(19) United States
(12) Patent Application Publication
(10) Pub. No.: US 2005/0214474 A1
(43) Pub. Date: Sep. 29, 2005

(54) Kinetic spray nozzle system design

(76) Inventors: Taeyoung Han, Bloomfield Hills, MI (US); Zhibo Zhao, Ann Arbor, MI (US); Bryan A. Gillispie, Warren, MI (US); John R. Smith, Birmingham, MI (US)

Correspondence Address: SCOTT A. McBAIN;DELPHI TECHNOLOGIES, INC., Legal Staff, Mail Code: 480-410-202, P.O. Box 5052, Troy, MI, 48007-5052, US

(21) Appl. No.: 10/808,245

(22) Filed: Mar. 24, 2004

(51) Int. Cl. B05C 5/00

(52) U.S. Cl. 427/446; 427/421.1; 118/302

(57) ABSTRACT

An improved kinetic spray nozzle system is disclosed in addition to improved methods for injection particle powders into a nozzle. Utilization of the nozzle enables one to dramatically increase the deposition efficiency of a variety of particles using a kinetic process. The improved nozzle includes a powder/gas conditioning chamber that increases the particle residence time within the nozzle enabling one to achieve higher particle temperatures prior to their acceleration in the supersonic portion of the kinetic spray nozzle.

### TECHNICAL FIELD

The present invention relates to spraying of powders by a kinetic spray process, and particularly, to an improved nozzle system for a kinetic spray system.

### INCORPORATION BY REFERENCE

U.S. Pat. No. 6,139,913, “Kinetic Spray Coating Method and Apparatus,” and U.S. Pat. No. 6,283,386 “Kinetic Spray Coating Apparatus” are incorporated by reference herein.

### BACKGROUND OF THE INVENTION

The prior art for kinetic spray systems generally discloses a kinetic spray system having a nozzle system that includes a gas/powder exchange chamber directly connected to a converging diverging deLaval type supersonic nozzle. The system introduces a stream of powder particles under positive pressure into the exchange chamber. The powder gas, which is used to drive the powder to the exchanger chamber, is not heated to prevent powder from clogging the powder pipeline. A heated main gas is also introduced into the exchange chamber under a pressure, which is set lower than the pressure of the powder particle stream. In the exchange chamber the heated main gas and the particles mix and because of the very short residence time, the power particles are heated only slightly and significantly below their melting point. The heated main gas and the particles flow from the exchange chamber into the supersonic nozzle where the particles are accelerated to a velocity of from 200 to 1,300 meters per second. The particles exit the nozzle and adhere to a substrate placed opposite the nozzle provided that a critical velocity has been exceeded.

The critical velocity of a particle is dependent upon its material composition and its size. Harder particles generally need a higher velocity to result in adherence and it is more difficult to accelerate large particles. The prior art system has been shown to work with many different types of particles, however, some particle sizes and material compositions have not been successfully sprayed to date. Prior to the present invention numerous attempts have been made to coat substrates with harder particles or larger particles. These attempts have been unsuccessful. For example, nickel and nickel alloys have not been successfully sprayed in an efficient manner to date. In addition, the coating density and deposition efficiency of the particles can be very low with harder to spray particles. The particle velocity upon exit from the nozzle varies inversely to the particle size and the particle density. Increasing the velocity of the main gas should increase the particle velocity upon exit. There is a limit, however, to the main gas velocities that can be achieved within the system. Thus, there is a need to develop a suitable system that will result in sufficient adherence of relatively high density, hard particles of a larger size to make the system practical.

### SUMMARY OF THE INVENTION

In one embodiment, the present invention is a method of kinetic spray coating a substrate comprising the steps of: providing particles of a powder; injecting the particles into a gas/powder exchange chamber and entraining the particles into a flow of a main gas in the gas/powder exchange chamber, the main gas at a temperature insufficient to heat the particles to a temperature above a melting temperature of the particles; directing the particles entrained in the main gas in the gas/powder exchange chamber into a powder/gas conditioning chamber having a length along a longitudinal axis of equal to or greater than 20 millimeters; and directing the particles entrained in the flow of gas from the conditioning chamber into a converging diverging supersonic nozzle, thereby accelerating the particles to a velocity sufficient to result in adherence of the particles on a substrate positioned opposite the nozzle.

In another embodiment, the present invention is a kinetic spray nozzle comprising: a gas/powder exchange chamber, a powder/gas conditioning chamber, and a converging diverging supersonic nozzle; the conditioning chamber having a length along a longitudinal axis equal to or greater than 20 millimeters; and the conditioning chamber positioned between the exchange chamber and the supersonic nozzle with the conditioning chamber in communication with the exchange chamber and the supersonic nozzle.

### BRIEF DESCRIPTION OF THE DRAWINGS

FIG. 1 is a schematic layout illustrating a kinetic spray system for using the nozzle of the present invention;

FIG. 2 is an enlarged cross-sectional view of a prior art nozzle system for use in a kinetic spray system;

FIG. 3 is an enlarged cross-sectional view of a nozzle system designed in accordance with the present invention for use in a kinetic spray system;

FIG. 4 is a graph showing the calculated particle temperature as a function of distance upstream and downstream in the nozzle for a series of temperatures for a nozzle designed in accordance with the prior art or a nozzle designed in accordance with the present invention;

FIG. 5 is a graph showing the calculated particle temperature at impact for each of the temperatures and nozzles shown in FIG. 4;

FIG. 6 is a graph showing the deposition efficiency of a nickel powder versus the traverse speed for a prior art nozzle and the nozzle system designed according to the present invention;

FIG. 7 is a graph representing the deposition efficiency of a nickel powder, a Cu—Ni alloy powder (38 wt % Ni), and a Ni—Cr alloy powder (20 wt % Cr) using either a prior art nozzle or one designed according to the present invention;

FIG. 8 is a graph showing the high deposition efficiency of Ti powder on various substrates with the use of a powder/gas conditioning chamber having a length L of 420 millimeters;

FIG. 9 is a graph showing the effect of powder/gas conditioning chamber length on deposition efficiencies of copper-coated silicon carbide powder for a series of main gas temperatures;

Figure 10A is a graph showing the calculated particle temperature at impact for copper-coated silicon carbide powder for a series of main gas temperatures using either a prior art nozzle or one designed in accordance with the present invention;

Figure 10B shows the corresponding deposition efficiencies for the conditions shown in FIG. 10A;

FIG. 11A is a scanning electron micrograph showing a cross-section through a copper-coated silicon carbide coating deposited using a nozzle designed in accordance with the present invention;

FIG. 11B is a scanning electron micrograph cross-sectional view of a copper-coated silicon carbide coating produced using a prior art nozzle;

FIG. 12A is a schematic of a setup used for testing adhesion of a copper-coated silicon carbide coating to a substrate;

FIG. 12B is a graph showing the effect of powder/gas conditioning chamber length on adhesive strength of a copper-coated silicon carbide coating to a substrate;

FIG. 13A is a cross-sectional view of an alternative embodiment of a nozzle designed in accordance with the present invention;

FIG. 13B is a cross-sectional view showing the intersection of the injector tube with the gas/powder exchange chamber of the nozzle shown in FIG. 13A;

FIG. 13C shows an alternative embodiment of the intersection of an injector tube with the gas/powder exchange chamber of the nozzle shown in FIG. 13A;

FIG. 14 is a graph showing the calculated residence time versus particle path length for particles injected into nozzles designed in accordance with the present invention;

FIG. 15 is a graph representing the calculated particle temperature versus particle path length for particles injected into nozzles designed in accordance with the present invention; and

FIG. 16 is a graph showing the calculated particle velocity upon exit from a nozzle for a series of nozzles designed in accordance with the present invention.

### DESCRIPTION OF THE PREFERRED EMBODIMENT

The present invention comprises a dramatic improvement to the kinetic spray process and nozzle system as generally described in U.S. Pat. Nos. 6,139,913, 6,283,386 and the article by Van Steenkiste, et al. entitled “Kinetic Spray Coatings” published in Surface and Coatings Technology Volume III, Pages 62-72, Jan. 10, 1999, all of which are herein incorporated by reference.

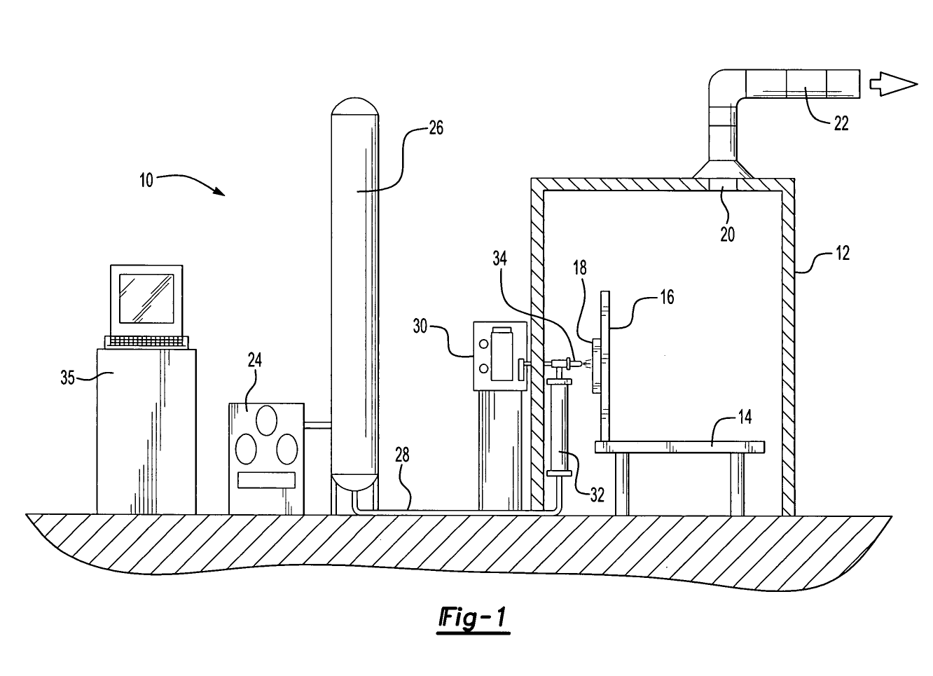

Referring first to FIG. 1, a kinetic spray system for use of a nozzle designed according to the present invention is generally shown at 10. System 10 includes an enclosure 12 in which a support table 14 or other support means is located. A mounting panel 16 fixed to the table 14 supports a work holder 18 capable of movement in three dimensions and able to support a suitable workpiece formed of a substrate material to be coated. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes a gas compressor 24 capable of supplying gas pressure up to 3.4 MPa (500 psi) to a high pressure gas ballast tank 26. Many gases can be used in the present invention including air, helium, argon, nitrogen, and other noble gases. The gas ballast tank 26 is connected through a line 28 to both a high pressure powder feeder 30 and a separate gas heater 32. The gas heater 32 supplies high pressure heated gas, the heated main gas described below, to a kinetic spray nozzle 34. The powder feeder 30 mixes particles of a powder to be sprayed with unheated high pressure gas and supplies the mixture to a supplemental inlet line 48 of the nozzle 34. The powder gas is not heated to prevent powder lines from clogging. A computer control 35 operates to control the pressure of gas supplied to the gas heater 32, the pressure of gas supplied to the powder feeder 30, and the temperature of the heated main gas exiting the gas heater 32.

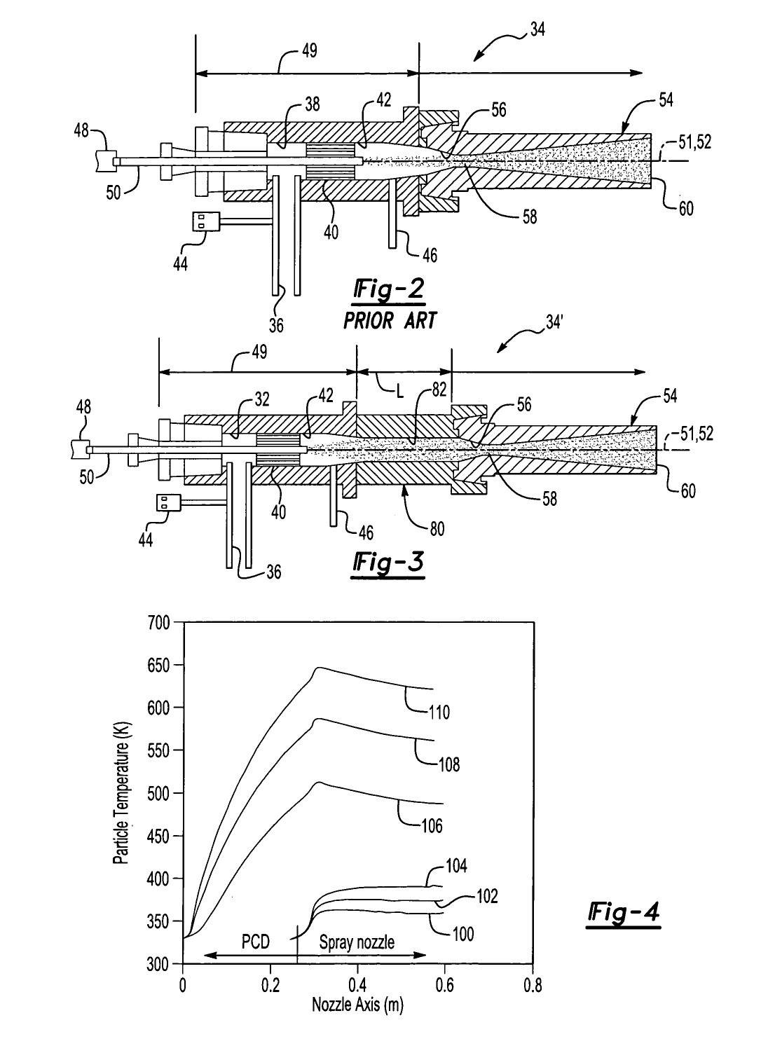

FIG. 2 is a cross-sectional view of a prior art nozzle 34 for use in the system 10 and its connections to the gas heater 32 and the supplemental inlet line 48. A main gas passage 36 connects the gas heater 32 to the nozzle 34. Passage 36 connects with a premix chamber 38 which directs gas through a flow straightener 40 and into a mixing chamber 42. Temperature and pressure of the gas or other heated main gas are monitored by a gas inlet temperature thermocouple 44 in the passage 36 and a pressure sensor 46 connected to the mixing chamber 42. The premix chamber 38, flow straightener 40, and mixing chamber 42 form a gas/powder exchange chamber 49.

A mixture of high pressure gas and coating powder is fed through the supplemental inlet line 48 to a powder injector tube 50 having a central axis 52 which, in this embodiment, preferentially is the same as a central axis 51 of the gas/powder exchange chamber 49. The length of chamber 49 is preferably from 40 to 80 millimeters and the exit of injector tube 50 is preferably from about 10 to 30 millimeters from the adjacent end of a supersonic nozzle 54. Preferably, the injector tube 50 has an inner diameter of from about 0.3 to 3.0 millimeters. The tube 50 extends through the premix chamber 38 and the flow straightener 40 into the mixing chamber 42.

Mixing chamber 42 is in communication with a de Laval type converging diverging nozzle 54. The nozzle 54 has an entrance cone 56 that decreases in diameter to a throat 58. The entrance cone 56 forms the converging portion of the nozzle 54. Downstream of the throat is an exit end 60. The largest diameter of the entrance cone 56 may range from 10 to 6 millimeters, with 7.5 millimeters being preferred. The entrance cone 56 narrows to the throat 58. The throat 58 may have a diameter of from 1.0 to 5.0 millimeters, with from 2 to 3 millimeters being preferred. The diverging portion of the nozzle 54 from downstream of the throat 58 to the exit end 60 may have a variety of shapes, but in a preferred embodiment it has a rectangular cross-sectional shape. At the exit end 60 the nozzle 54 preferably has a rectangular shape with a long dimension of from 6 to 24 millimeters by a short dimension of from 1 to 6 millimeters.

As disclosed in U.S. Pat. Nos. 6,139,913 and 6,283,386 the powder injector tube 50 supplies a particle powder mixture to the system 10 under a pressure in excess of the pressure of the heated main gas from the passage 36. The nozzle 54 produces an exit velocity of the entrained particles of from 200 meters per second to as high as 1300 meters per second. The entrained particles gain primarily kinetic energy during their flow through the nozzle 34. It will be recognized by those of skill in the art that the temperature of the particles in the gas stream will be low and varies depending on the particle size and the main gas temperature. The main gas temperature is defined as the temperature of heated high-pressure gas at the inlet to the nozzle 54. The main gas temperature can be substantially above the melting temperature of the particles being sprayed. In fact, the main gas temperature can vary from about 200 to 1000 degrees Celsius or as high as 7 fold above the melting point of the particles being sprayed depending on the particle material. Despite these high main gas temperatures the particle temperature is at all times significantly lower than the melting point of the particles. This is because the powders are injected into the heated gas stream by the unheated powder gas and the exposure time of the particles to the heated main gas is very short. In other words, the particle energy at the exit of nozzle 34 is predominantly kinetic energy. Therefore, even upon impact there is no change in the solid phase of the original particles due to transfer of kinetic and thermal energy, and no change in their original physical properties. The particles are always at a temperature below their melting point. The particles exiting the nozzle 54 are directed toward a surface of a substrate to coat it.

Upon striking a substrate opposite the nozzle 54 the particles flatten into a nub-like structure with a varying aspect ratio generally depending on the types of sprayed materials. When the substrate is a metal and the particles are a metal the particles striking the substrate surface fracture the surface oxide layer and subsequently form a direct metal-to-metal bond between the metal particle and the metal substrate. Upon impact the kinetic sprayed particles transfer all of their kinetic and thermal energy to the substrate surface and stick onto the substrate. As discussed above, for a given particle to adhere to a substrate it is necessary that it reach or exceed its critical velocity which is defined as the velocity at which it will adhere to a substrate when it strikes the substrate after exiting the nozzle. This critical velocity is dependent on the material composition of the particle and the material composition of the substrate. In general, harder materials must achieve a higher critical velocity before they adhere to a given substrate and harder substrates must be struck at a higher velocity. It is not known at this time exactly what is the nature of the particle to substrate bond; however, it is believed that for the metal particles incident on a metal substrate, a portion of the bond is metallic or metal to metal due to the particles plastically deforming upon striking the substrate and thereby fracturing oxide layers exposing the underlying metal.

As disclosed in U.S. Pat. No. 6,139,913 the substrate material may be comprised of any of a wide variety of materials including a metal, an alloy, a plastic, a polymer, a ceramic, a wood, a semiconductor, and mixtures of these materials. All of these substrates can be coated by the process of the present invention. The particles used in the present invention may comprise any of the materials disclosed in U.S. Pat. Nos. 6,139,913 and 6,283,386 in addition to other know particles. These particles generally comprise a metal, an alloy, a ceramic, a polymer, a diamond, a metal coated ceramic, a semiconductor, and mixtures of these. Preferably, the particles have an average nominal diameter of from about 1 to 250 microns.

FIG. 3 is a cross-sectional view of a nozzle system designed in accordance with the present invention. The spray nozzle is generally shown at 34′ in FIG. 3. The nozzle 34′ is similar to that shown in FIG. 2 with the addition of a powder/gas conditioning chamber 80 positioned between the gas/powder exchange chamber 49 and the supersonic nozzle 54. The powder/gas conditioning chamber 80 has a length L along its longitudinal axis. The axis 52 is the same as axis 51 in this embodiment. Preferably the interior of the powder/gas conditioning chamber 80 has a cylindrical shape 82. Also preferably its interior diameter matches the entrance of the converging portion of the spray nozzle. The powder/gas conditioning chamber 80 releasably engages both the supersonic nozzle 54 and the gas/powder exchange chamber 49. Preferably, the releasable engagement is via correspondingly engaging threads on the gas/powder exchange chamber 49, the nozzle 54, and the powder/gas conditioning chamber 80 (not shown). The releaseable engagement could be via other means such as snap fits, bayonet-type connections and others known to those of skill in the art. The length L along the longitudinal axis is preferably at least 20 millimeters or longer. The optimal length of the powder/gas conditioning chamber 80 depends on the particles that are being sprayed and the substrate that is being sprayed with the particles. The optimal length L can be determined experimentally. Preferably the length L ranges from 20 to 1000 millimeters. It has been found that by including a powder/gas conditioning chamber 80 designed in accordance with the present invention one can achieve dramatic increases in deposition efficiency and the ability to use lower main gas temperatures to deposit particles that previously were not able to be deposited. With the insertion of the powder/gas conditioning chamber 80, the distance between the exit of the injector tube 50 and the adjacent end of the nozzle 54 is significantly increased. The increased distance permitted by the conditioning chamber 80 allows for a longer residence time of the particles in the main gas prior to entry into the supersonic nozzle 54. This longer residence time leads to a higher particle temperature, more homogeneous main gas powder intermixing, and a more homogeneous flow of the gas powder mixture. Thus, it is predicted that particles will achieve a higher temperature, closer to but still below their melting point, prior to entry into the supersonic nozzle 54.

To understand the results achieved using a nozzle system designed in accordance with the present invention computational simulations were conducted in conjunction with the experimental studies and the results are presented below. To perform the computational simulations a Computational Fluid Dynamics (CFD) program was utilized. The software utilized was Fluent 6.0 commercial CFD code available from Fluent Inc. Utilizing this software one is able to predict the gas flow characteristics inside the converging diverging nozzle 54 and the impinging supersonic turbulent jet on the substrate. The equations governing the steady-state kinetic spray process are the mass, momentum, and energy conservation equations for both gas phase and solid particles. The Fluent CFD code can handle interactions between the gas phase and the particles in terms of momentum and energy. To account for turbulence in a gas flow, a k-∈ turbulence model was employed. This model is found in the reference Transport Equations in Turbulence, in Physics of Fluids, 13, pages 2634-2649, 1997 by B. J. Daily and F. H. Harlow. As the gas flow is compressible, the density variations in the field are predicted based on the ideal gas law. For boundary conditions, the operating pressure and temperature were specified for the main gas at the inlet of the nozzle 54. At the powder injector, the main gas mass flow rate and powder mass feed rate and particle size distributions were simultaneously specified. At the nozzle 54 walls, a non-slip condition was used.

Depending on the powder feed rates, the main gas flow can influence discrete particles and vice versa. So, the interaction of particles with a gas flow was taken into account in the simulations. In a coupled approach, calculations of the gas phase and discrete particle phase were alternated until a converged coupled solution was achieved. Using the FLUENT code, calculations within the nozzle 34 and after the nozzle exit 60 were performed. The dispersion of particles due to turbulence in the gas flow was also considered via the stochastic tracking model. The reference for this model is Efficient Statistical Transport Model For Turbulent Particle Dispersion In Sprays, in AIAA Journal, 29:1443, 1991, by R. J. Litchford and S. M. Jeng. This model includes the effective instantaneous turbulent velocity fluctuations on the particle trajectories.

Utilizing the computational model one is able to predict gas flow, particle velocity, and particle temperatures in the spray process and the simulations were applied to understand the basic phenomenon of particle heat up due to the utilization of the powder/gas conditioning chamber 80.

FIG. 4 shows the results for a series of calculations for simulations done as described above for a nozzle 34′ as shown in FIG. 3. The designation PCD refers to the powder/gas conditioning chamber 80. For these simulations the length L of the powder/gas conditioning chamber 80 was set at either 0 or 240 millimeters. The particles utilized were assumed to be nickel with an average nominal size of 75 microns. Reference line 100 shows the predicted particle temperature when a length L of the powder/gas conditioning chamber 80 is 0 and the main gas temperature is set at 700 degrees Kelvin. Reference line 102 shows the predicted particle temperature when the length L of the powder/gas conditioning chamber 80 is 0 and the main gas temperature is 810 degrees Kelvin. Reference line 104 shows the predicted particle temperature when the length L is 0 and the main gas temperature is 922 degrees Kelvin. Reference line 106 shows the predicted particle temperature when the length L is 240 millimeters and the main gas temperature is 700 degrees Kelvin. Reference line 108 represents the predicted particle temperature when the length L is 240 millimeters and the main gas temperature is 810 degrees Kelvin. Finally, reference line 110 represents the predicted particle temperature when the length L is 240 millimeters and the main gas temperature is 922 degrees Kelvin. It can be seen from the results shown in FIG. 4 that one anticipates that the temperature of the particles will be anywhere from approximately 150 to 250 degrees Kelvin higher when utilizing a powder/gas conditioning chamber 80 having a length L of 240 millimeters versus no chamber 80.

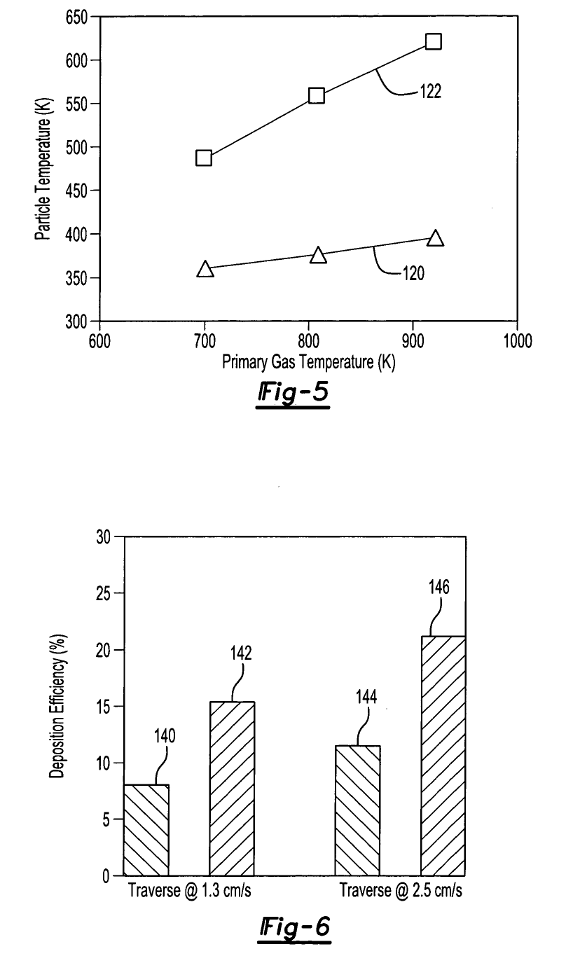

FIG. 5 represents the calculated particle temperature at impact assuming the offset distance between exit end 60 and a substrate is two centimeters using the conditions disclosed in FIG. 4 above. Reference line 120 represents the predicted particle temperature at impact when the length L is 0 millimeters. Reference line 122 represents the predicted particle temperatures at impact when the length L is 240 millimeters. It can be seen from the results that one anticipates that the particle temperature will be anywhere from approximately 150 to over 200 degrees higher utilizing the powder/gas conditioning chamber 80 of the present invention.

FIG. 6 is a graph showing the results of depositing a nickel powder using a prior art nozzle or the nozzle system designed in accordance with the present invention. In both cases, the powder was a nickel powder having an average nominal particle size of approximately 75 microns. The powder was sprayed onto aluminum alloy strips and the offset distance between the exit end 60 and the substrate was two centimeters. The main gas temperature utilized was 922 degrees Kelvin. Reference line 140 and 144 represent the deposition efficiency utilizing a nozzle system designed in accordance with the prior art which did not include a powder/gas conditioning chamber 80. Reference lines 142 and 146 represent the results wherein a nozzle system designed in accordance with the present invention including a powder/gas conditioning chamber 80 having a length L of 240 millimeters was utilized. It can be seen that the powder/gas conditioning chamber 80 has a dramatic effect on the deposition efficiency. Utilizing the powder/gas conditioning chamber 80 one is able to achieve almost a two-fold increase in the deposition efficiency of the nickel powder. It is known that the yield strength of many metals is dependent on their temperature. The yield strength of most metals decreases as their temperature increases and this may explain the observed results. This length, 240 millimeters, was not optimized for the nickel powder.

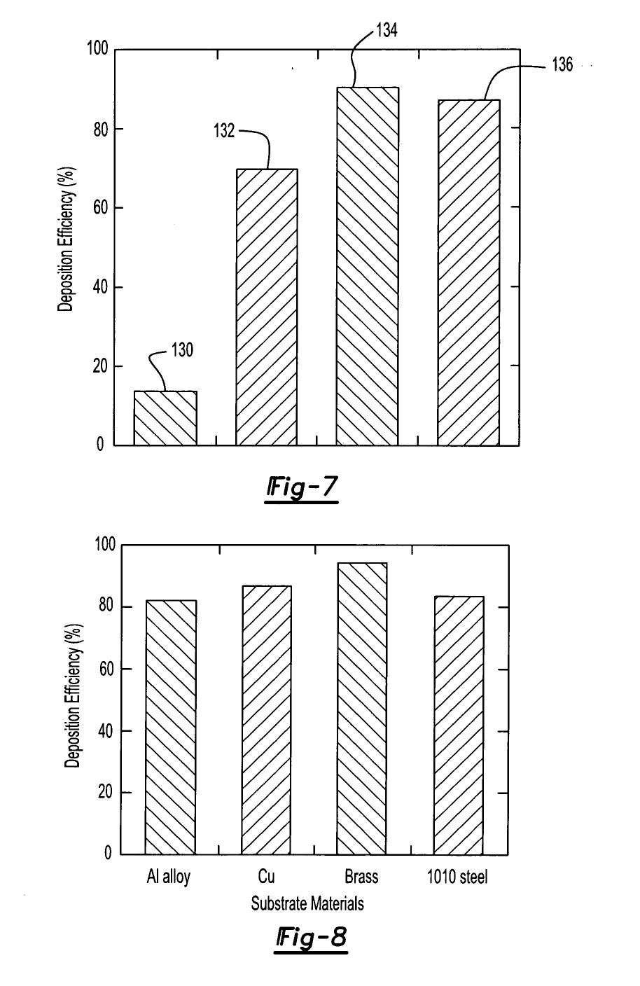

FIG. 7 is a graph showing the deposition efficiency of a Ni powder, a Cu—Ni alloy powder and a Ni—Cr alloy powder after the powder/gas conditioning chamber length has been optimized. The Cu—Ni alloy had 38% by weight nickel, the Ni—Cr alloy had 20% by weight chromium. In all cases the powders have an average size of approximately 76 microns, the offset distance was two centimeters, and the main gas temperature was set at 920 degrees Kelvin. The substrate was an aluminum alloy strip. Reference bar 130 represents the results using a nickel powder wherein L is equal to 0. Reference bar 123 is the nickel powder wherein L is equal to 400 millimeters. Reference bars 134 and 136 represent the Cu—Ni and Ni—Cr powders respectively wherein the length L is equal to 400 millimeters. It can be seen from the results that the deposition efficiency of these difficult to spray materials is 70-90% by using a powder/gas conditioning chamber 80 with length L equal to 400 millimeters designed in accordance with the present invention. While under the similar deposition condition using the prior art nozzle, the Ni powder only has a deposition efficiency of approximately 14%.

FIG. 8 demonstrates the effect of the powder/gas conditioning chamber 80 on deposition efficiency of Ti powders on a series of substrates. In all cases, the powder was gas-atomized Ti particles having an average nominal median size of approximately 100 microns. The offset distance in all cases was two centimeters. The main gas temperature utilized was 810 degrees Kelvin. It can be seen from the results that the deposition efficiency of Ti powder can be more than 80% with a length L of the powder/gas conditioning chamber 80 equal to 410 millimeters.

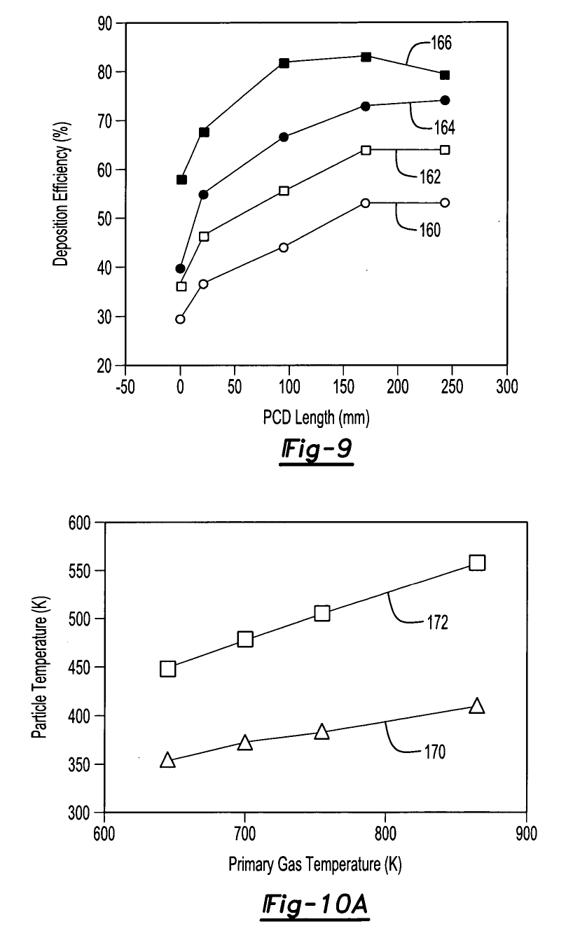

FIG. 9 presents the results for spraying of copper coated silicon carbide particles having the size of approximately 60 microns using a traverse speed of 2.5 centimeters per second and an offset distance of two centimeters. The results show the effect of length L of the powder/gas conditioning chamber 80 on the deposition efficiency for a series of main gas temperatures. In reference line 160, the main gas temperature was set at 645 degrees Kelvin. In reference line 162, the main gas temperature was set at 700 degrees Kelvin. In reference line 164, the main gas temperature was set at 755 degrees Kelvin. Finally, in reference line 166, the main gas temperature was set at 865 degrees Kelvin. The results demonstrate that at all of the main gas temperatures, the presence of the powder/gas conditioning chamber 80 had a significant effect on the deposition efficiency of the particles. In addition, the results suggest that the optimal length L for these particles at this size is approximately 170 millimeters. Going beyond this length to 243 millimeters did not lead to a significant increase in the deposition efficiencies. Utilizing a main gas temperature of 865 degrees Kelvin and a length L of the powder/gas conditioning chamber 80 of 170 millimeters allowed for a deposition efficiency of approximately 83%, which is well above that achievable in the absence of the powder/gas conditioning chamber 80 designed in accordance with the present invention.

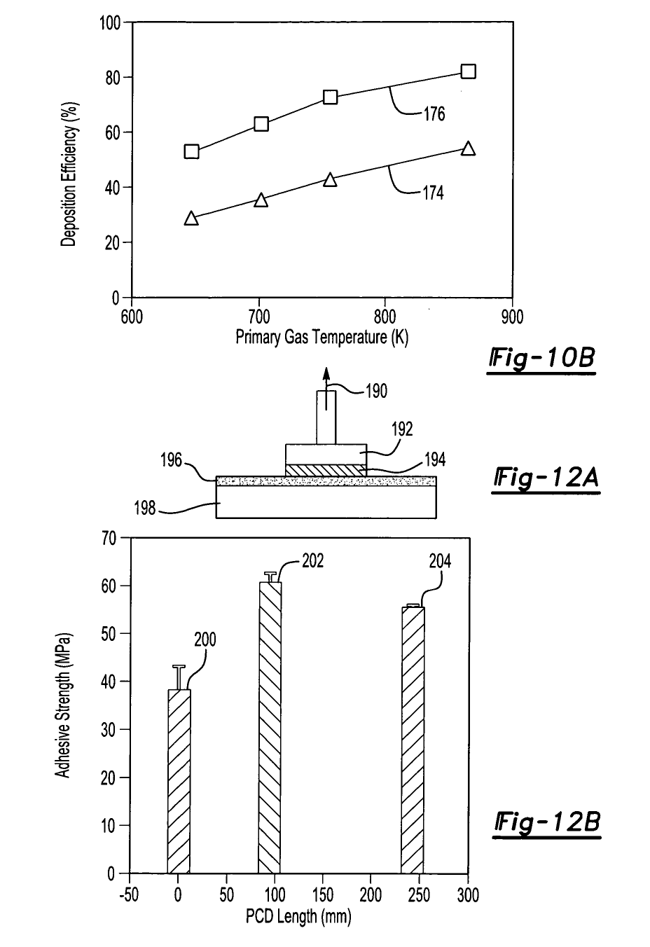

Figure 10A shows the calculated particle temperatures at impact for copper coated silicon carbide particles having a size of approximately 60 microns and an offset of two centimeters. Reference line 170 represents the condition wherein the length L of the powder/gas conditioning chamber 80 is 0 millimeters and reference line 172 represents a condition wherein the length L is 240 millimeters. It can be seen that the presence of the powder/gas conditioning chamber 80 leads to a dramatic increase in the predicted particle temperature at impact.

Figure 10B shows the actual results of deposition efficiency versus primary gas temperature for the condition wherein L equals 0, shown in reference line 174, and wherein L equals 240 millimeters, shown in reference line 176. These results demonstrate that the deposition efficiency closely tracks the predicted increase in particle temperature upon impact. Significantly, there was almost no change in the particle velocity upon exit from the nozzle 54 under either of these conditions. Therefore, it is believed that the majority of the increase in deposition efficiency is due to the increase in the particle temperature caused by the presence of the powder/gas conditioning chamber 80. In no case, however, did the particles achieve a temperature that is at or above their melting point, thus their physical state is not changed even by utilization of the powder/gas conditioning chamber 80 designed in accordance with the present invention.

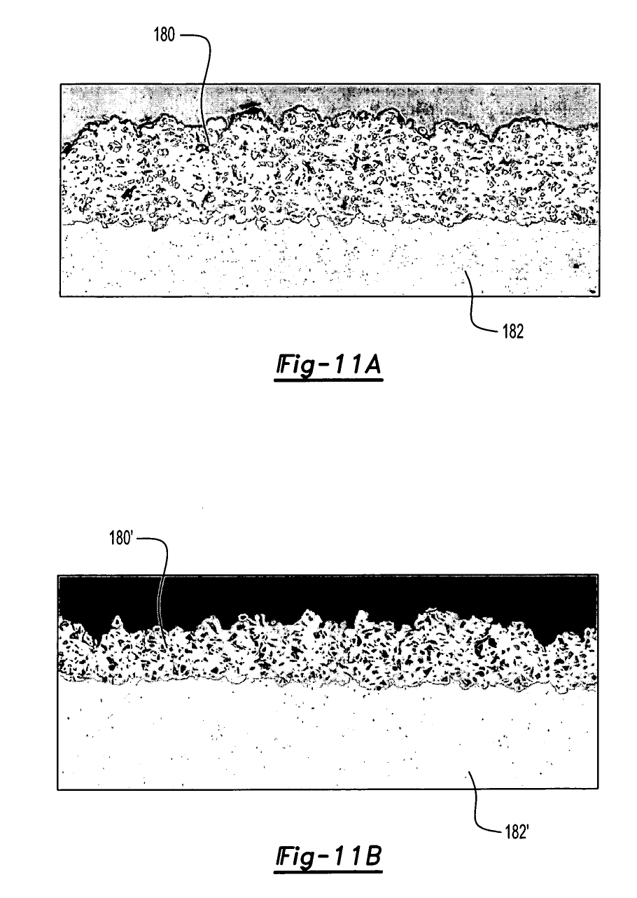

FIG. 11A is a cross-sectional scanning electron microscopy photograph of a copper coated silicon carbide coating 180 deposited onto an aluminum alloy substrate 182 utilizing a nozzle 34′ having a powder/gas conditioning chamber 80 with a length L of 95 millimeters.

In FIG. 11B the coating 180′ was deposited on the same substrate 182′ utilizing a nozzle 34 not having a powder/gas conditioning chamber 80. It can be seen that the presence of the powder/gas conditioning chamber 80 leads to a more uniform and thicker coating than in its absence.

To test the effect of the powder/gas conditioning chamber 80 on the adhesive strength of a coating on to a substrate a series of experiments were performed. FIG. 12A is a schematic representing the experimental setup. In all cases, the coating was created utilizing copper coated silicon carbide particles with a particle size of approximately 60 microns and an offset of two centimeters. All of the coatings were initially polished with 400 grit silicon carbide abrasive paper prior to use in the test. The results represent four separate tests for each condition. The direction of the force is shown in reference arrow 190. The pull stud is represented by 192 the epoxy utilized is represented by 194, the coating is 196, and the substrate is 198. The tests were performed using a Romulus IV Universal Materials Tester available from Quad Group, Inc. In reference bar 200, the results are presented for a nozzle 34 wherein the length L of the powder/gas conditioning chamber 80 is 0. Reference bar 202 represents the results for a nozzle 34 wherein the length L of the powder/gas conditioning chamber 80 is 95 millimeters. Finally, bar 204 represents the results wherein the length L of the powder/gas conditioning chamber 80 is 243 millimeters. It can be seen that the presence of the powder/gas conditioning chamber 80 leads to a significant increase in the adhesive strength of the coating 196 on the substrate 198.

A series of additional powders were tested in an attempt to determine the optimal conditions for deposition efficiency in the presence or absence of a powder/gas conditioning chamber 80 designed in accordance with the present invention. The results are presented below in Table 1. It can be seen that the presence of the powder/gas conditioning chamber 80 allowed for a dramatic increase in the deposition efficiency that can be achieved with a wide variety of particles. This effect was observed even for particles that are extremely hard such as nickel. The results were unexpected and appeared with very little change in particle velocities achieved utilizing the system 10. Thus, it is believed that most of the increase in the deposition efficiency occurs because of the ability of the powder/gas conditioning chamber 80 to raise the particle temperature prior to entry of the particles into the supersonic nozzle 54.

TABLE 1

| | | | | Deposition |
|---|---|---|---|---|
| | | | Maximum | Efficiency |
| | | | Deposition | With |
| | | | Efficiency | Optimized |
| | Particle Size | Particle | Without | Length L of |
| Powder | Distribution | Hardness, | Conditioning | Conditioning |
| Composition | in Microns | GPa | Chamber | Chamber |
| Al—Zn—Si alloy | 53-106 | 170 | 30% | >70% |
| Cu | 53-96 | 105 | 45% | >85% |
| Cu coated SiC | 53-75 | 105 | 55% | 75% |
| Ni | 53-90 | 350 | 14% | >80% |
| CuNi alloy | 53-75 | 195 | Not tested | >90 |
| NiCr alloy | 53-75 | 340 | Not tested | >80% |

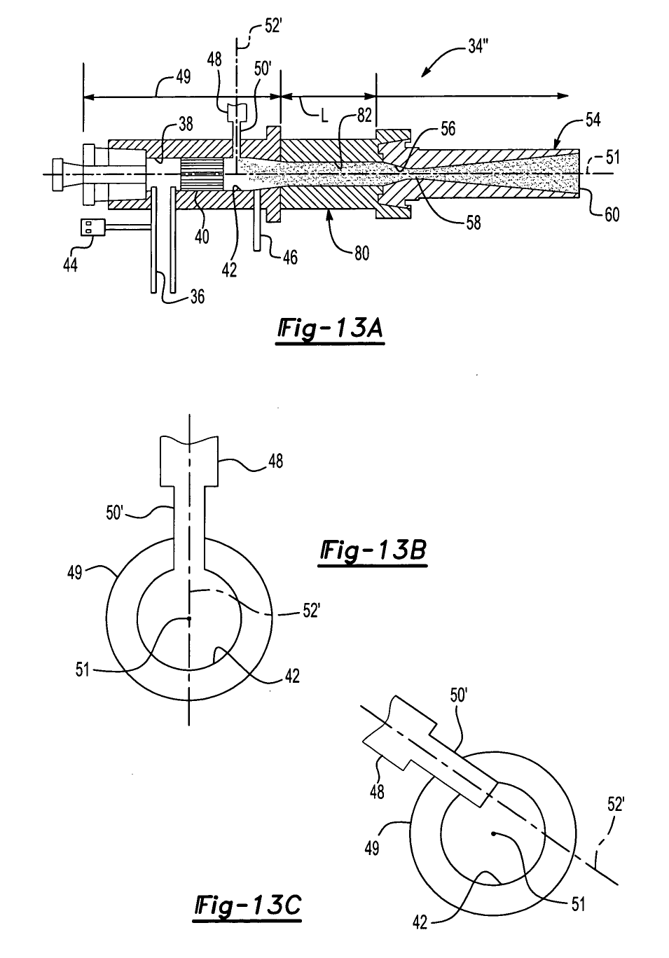

From the results presented above, it is clear that utilization of a powder/gas conditioning chamber 80 can result in dramatic improvement in the ability to spray a wide variety of particles onto substrates. It is believed that the majority of the increase in deposition efficiency is due to an increase in particle temperature prior to entry into the nozzle 54 which is achieved because of a longer particle residence time with the powder/gas conditioning chamber 80 present. All of the results presented above were generated utilizing a system 10 wherein the central axis 52 of the injector 50 was parallel to the central axis 51 of the gas/powder exchange chamber 49, the powder/gas conditioning chamber 80, and the supersonic nozzle 54. In an alternative embodiment, shown in FIG. 13A, the central axis 52′ of the injector 50′ and the central axis 51 of the gas/powder exchange chamber 49 are not parallel.

FIGS. 13B and 13C show two possibilities. In FIG. 13B, the angle of the central axis 52′ to the central axis 51 is greater than 0 to 90 degrees, referred to herein and in the claims as an oblique angle. In FIG. 13C the central axis 52′ is tangential to the gas/powder exchange chamber 49. Having the injector 50 positioned as shown in FIG. 3 is referred to as an axial injection, with the injector 50 positioned as shown in FIG. 13B it is referred to as a vertical injection or oblique injection, and with the injector 50′ at tangential angle relative to the gas/powder exchange chamber 49 as shown in FIG. 13C it is referred to as a swirl injection or tangential injection in the discussions below. It is anticipated that utilizing an injection 50′ positioned as shown in FIGS. 13B and 13C should also lead to an increase in the particle residence time within the nozzle 34′. This is expected because the particle travel path will not be as straight through chamber 80 as for the embodiment shown in FIG. 3.

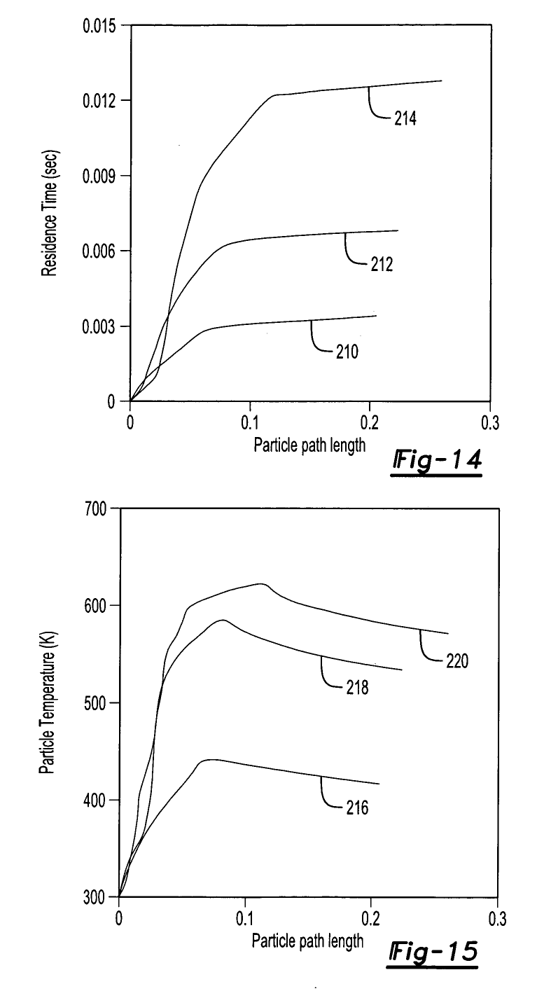

FIG. 14 represents the calculated residence times versus particle path length for each of the three injector positions described above using the models described above. In reference line 210, the residence time is shown for the condition wherein the particles are injected axially, i.e., the angle between central axis 51 and 52 is zero degrees. Reference line 212 represents the predicted residence time versus particle path length for a system wherein the angle between central axis 52′ and 51 is 90 degrees, i.e., vertical injection. Finally, reference line 214 represents the predicted residence time versus particle path length for the situation wherein the angle between the gas/powder exchange chamber 49 and 52′ is tangential, i.e., swirl injection. From the simulated residence times it can be seen that using either the vertical injection or the swirl injection should lead to a significant increase in the particle residence time thereby providing for a higher particle temperature upon entry of the particles into the supersonic nozzle 54.

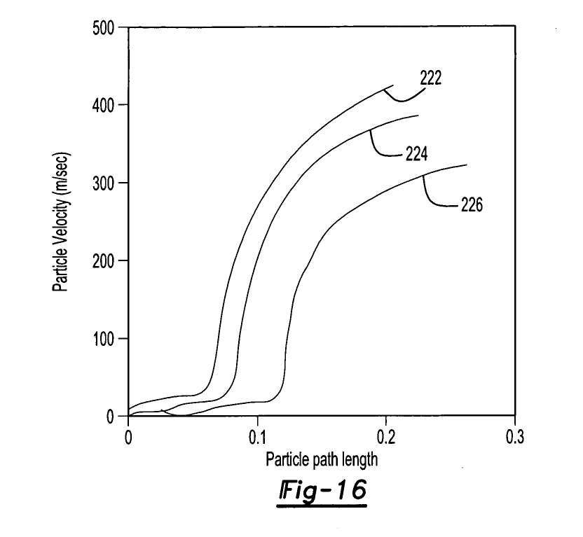

FIG. 15 represents the calculated results for the three injection methods presented at particle temperature versus particle path length. Reference line 216 is for a system wherein the injection is axial. Reference line 218 represents a system wherein the injection is a vertical injection. Reference line 220 represents a condition wherein the injection is a swirl injection. It can be seen from the results that either the vertical or the swirl injection should lead to a significant increase in the particle temperature as the particles move through the nozzle 34.

In FIG. 16, the particle velocity as a function of the particle path length was calculated and displayed for the three types of injection. Reference line 222 represents a condition wherein the injection is an axial injection. Reference line 224 is the predicted particle velocity for a vertical injection. Finally, reference line 226 is a predicted particle velocity for a swirl injection. It can be seen from the results that the vertical injection does not result in a very significant decrease in the particle velocity, however, the swirl injection will result in a significant decrease in the particle velocity. It is believed that the swirl injection will reduce the particle velocity because of the nature of the particle pathway within the nozzle following a swirl injection. The results demonstrate that combining either a vertical or swirl injection with the powder/gas conditioning chamber 80 is predicted to enable one to deposit materials with an even higher deposition efficiency than that achieved utilizing only the powder/gas conditioning chamber 80 alone. In addition, use of either the vertical or swirl injection method is expected to enable one to deposit particles that are not able to be deposited utilizing only a powder/gas conditioning chamber 80 designed in accordance with the present invention.

1. A method of kinetic spray coating a substrate comprising the steps of:
a) providing particles of a powder;
b) injecting the particles into a gas/powder exchange chamber and entraining the particles into a flow of a main gas in the gas/powder exchange chamber, the main gas at a temperature insufficient to heat the particles to a temperature above a melting temperature of the particles;
c) directing the particles entrained in the main gas in the gas/powder exchange chamber into a powder/gas conditioning chamber having a length along a longitudinal axis of equal to or greater than 20 millimeters; and
d) directing the particles entrained in the flow of gas from the conditioning chamber into a converging diverging supersonic nozzle, thereby accelerating the particles to a velocity sufficient to result in adherence of the particles on a substrate positioned opposite the nozzle.

2. The method as recited in claim 1, wherein step a) comprises providing as the particles at least one of an alloy, a metal, a ceramic, a polymer, a metal coated ceramic, a semiconductor, or mixtures thereof.

3. The method as recited in claim 1, wherein step a) comprises providing particles having an average nominal diameter of from about 1 microns to 250 microns.

4. The method as recited in claim 1, wherein step b) comprises injecting the particles under a pressure that is from about 5 to 300 pounds per square inch above a pressure of the main gas.

5. The method as recited in claim 1, wherein the main gas is at a temperature of from about 200 to 1000 degrees Celsius

6. The method as recited in claim 1, wherein step b) comprises injecting the particles parallel to a longitudinal axis of the gas/powder exchange chamber.

7. The method as recited in claim 1, wherein step b) comprises injecting the particles at one of an oblique angle relative to a longitudinal axis of the gas/powder exchange chamber or at a tangential angle relative to the gas/powder exchange chamber.

8. The method as recited in claim 1, wherein step c) comprises directing the entrained particles into a powder/gas conditioning chamber having a longitudinal axis of from about 20 millimeters to about 1000 millimeters.

9. The method as recited in claim 1, wherein step d) comprises accelerating the particles to a velocity of from about 200 to about 1500 meters per second.

10. The method as recited in claim 1, wherein step d) comprises providing a substrate comprising at least one of a metal, an alloy, a plastic, a polymer, a ceramic, a wood, a semiconductor or a mixture thereof.

11. A kinetic spray nozzle system comprising:
a gas/powder exchange chamber, a powder/gas conditioning chamber, and a converging diverging supersonic nozzle;
said conditioning chamber having a length along a longitudinal axis equal to or greater than 20 millimeters; and
said conditioning chamber positioned between said exchange chamber and said supersonic nozzle with said conditioning chamber in communication with said exchange chamber and said supersonic nozzle.

12. The kinetic spray nozzle system as recited in claim 11, wherein said conditioning chamber has preferably a circular cross-sectional shape.

13. The kinetic spray nozzle system as recited in claim 11, wherein said length along said longitudinal axis is from about 20 millimeters to about 1000 millimeters.

14. The kinetic spray nozzle system as recited in claim 11, further comprising a particle injector tube in communication with said exchange chamber.

15. The kinetic spray nozzle system as recited in claim 14, wherein said injector tube has a longitudinal axis that is parallel to a longitudinal axis of said gas/powder exchange chamber.

16. The kinetic spray nozzle system as recited in claim 14, wherein said injector tube has a longitudinal axis that is one of at an angle of 90 degrees with respect to a longitudinal axis of said gas/powder exchange chamber or at a tangential angle relative to the gas/powder exchange chamber.

17. The kinetic spray nozzle system as recited in claim 14, wherein said injector tube has an internal diameter of from about 0.3 to about 3.0 millimeters.

18. The kinetic spray nozzle system as recited in claim 11, wherein said converging diverging supersonic nozzle has a throat with a diameter of from about 1.0 to about 5.0 millimeters.

19. The kinetic spray nozzle system as recited in claim 11, wherein said conditioning chamber releasably engages said gas/powder exchange chamber and said converging diverging supersonic nozzle

20. The kinetic spray nozzle system as recited in claim 19 wherein said conditioning chamber includes a plurality of threaded portions, one of which releasably engages a corresponding threaded portion on said gas/powder exchange chamber and another of which releasably engages a corresponding threaded portion on said converging diverging supersonic nozzle.
